(19) United States
(12) Patent Application Publication
(10) Pub. No.: US 2016/0054951 A1
(43) Pub. Date: Feb. 25, 2016

(54) APPARATUS AND METHOD FOR OPTIMIZING TIME SERIES DATA STORAGE

(71) Applicant: GE Intelligent Platforms, Inc., Charlottesville, VA (US)

(72) Inventors: Sunil MATHUR, Foxboro, MA (US); Kareem Sherif AGGOUR, Niskayuna, NY (US); Ward BOWMAN, Foxboro, MA (US); Brian COURTNEY, Lisle, IL (US); Justin DeSpenza MCHUGH, Niskayuna, NY (US)

(21) Appl. No.: 14/777,858

(22) PCT Filed: Mar. 18, 2013
(86) PCT No.: PCT/US2013/032806

§ 371 Date: Sep. 17, 2015

(51) Int. Cl. G06F 3/06

(52) U.S. Cl. CPC G06F 3/0649; G06F 3/0605; G06F 3/0685

(57) ABSTRACT

Characterization information related to time series data is obtained. A data storage rule is automatically determined based upon the characterization information. The rule defines at least one of a location for the storage of the time series data and a format for storage of the time series data. The rule is applied to the time series data and the time series data is stored according to the rule.

### CROSS REFERENCES TO RELATED APPLICATIONS

International application no. PCT/US2013/032803 filed Mar. 18, 2013 and published as WO2014149027 A1 on Sep. 25, 2014 and entitled “Apparatus and Method for Optimizing Time Series Data Storage Based Upon Prioritization”;

International application no. PCT/US2013/032802 filed Mar. 18, 2013 and published as WO2014149026 A1 on Sep. 25, 2014 and entitled “Apparatus and method for Memory Storage and Analytic Execution of Time Series Data”

International application no. PCT/US2013/032810 filed Mar. 18, 2013 and published as WO2014149029 A1 on Sep. 25, 2014 and entitled “Apparatus and Method for Executing Parallel Time Series Data Analytics”;

International application no. PCT/US2013/032823 filed Mar. 18, 2013 and published as WO2014149031 A1 on Sep. 25, 2014 and entitled “Apparatus and Method for Time Series Query Packaging”;

International application no. PCT/US2013/032801 filed Mar. 18, 2013 and published as WO2014149025 A1 on September 25, 2014 and entitled “Apparatus and Method for Optimizing Time Data Store Usage”;

are being filed on the same date as the present application, the contents of which are incorporated herein by reference in their entireties.

### BACKGROUND OF THE INVENTION

1. Field of the Invention

The subject matter disclosed herein relates to optimizing the storing of data and, more specifically, to optimizing the storage of time series data.

2. Brief Description of the Related Art

Data is stored on data storage devices in a variety of different formats. Additionally, various types of data storage devices are used to store data and these data storage devices may vary in cost. In one example, data may be stored according to certain formats on high cost devices such as random access memories (RAMs). In other examples, data may be stored on low cost devices such as on hard disks.

One type of data that is stored on data storage devices is time series data. In one aspect, time series data is obtained by some type of sensor or measurement device and the data is then stored as a function of time. For example, a measurement sensor may take a reading of a parameter at predetermined time intervals, and each of the measurements is stored in a data storage device. Since large amounts of data are typically involved with time series measurements, the storage and retrieval of this data may become inefficient.

In many situations, a system developer develops a data storage plan before the system is actually built. For example, certain types of data may be used or need to be retrieved frequently and this type of data may be stored on high speed, but high cost memory. In other situations, certain data may not need to be accessed very frequently, and can therefore be stored on low speed, low cost devices.

The problem arises that data storage typically becomes inefficient over time. For instance, as data changes, as data access patterns change, or as data storage devices change, the data storage plan initially implemented may become inefficient. Time series data is particularly sensitive to these problems, since large amounts of data are at issue and inefficient data storage patterns have a detrimental effect on system operation.

### BRIEF DESCRIPTION OF THE INVENTION

The embodiments described herein determine how time series data is stored (e.g., based upon metadata or other information describing the assets, characteristics of the analytics to be executed against the data, or other types of information). The embodiments provided herein are automated, allowing the system to periodically adjust the storage decisions automatically without human intervention to optimize the efficient accessibility and utility of the data. These changes may, in some examples, be initiated by changes in either the asset models in use or the detection of changes in the collection of analytics used by data. In one example, the system may choose to store time series data in a variety of patterns or formats, and at a number of different types of storage media to improve storage times, access times or responsiveness based upon metadata and/or analytic requirements.

Embodiments of the present invention evaluate account information stored in both the asset models related to the time series data and metadata related to the known analytics executing in the system. By “asset model” it is meant information that relates the time series data to a physical system. These models assign a structured relationship between time series values referring to a particular measurement or sensor on an asset. This may include information relating to commonalities between assets and the expected frequency of generation for some time series values.

By “analytics” or “analytic programs” it is meant operations that manipulate or perform calculations on the time series data. Information related to the analytics is also used to determine the storage structure and physical location of the data. Information (e.g., cost and speed information) concerning system hardware can additionally be used to make these decisions.

The automation of these decisions allows the storage decisions to change over time with addition or subtraction of analytic work, the alteration of the asset models, and the changing of hardware parameters, to mention a few examples. These changes are made automatically, thereby altering the data storage decisions on the fly.

In many of these embodiments, characterization information related to time series data is obtained. A data storage rule is defined based upon the characterization information. The rule defines at least one of a location for the storage of the time series data or a format for storage of the time series data. The rule is applied to the time series data and the time series data is stored according to the rule.

In one aspect, the data storage rule is dynamically updated and changed over time according to the characterization information. In other aspects, the characterization information that is used to define the rule may be asset model information, analytic information, or hardware information (e.g., available disk space). Other examples of information can be used to define the rule.

In some aspects, the asset model information relates to an operational characteristic of an asset (such as an assembly line, a robotic controller, or a pumping device to mention a few examples). The analytic information may relate to an identity or other characteristics of one or more analytic programs. The hardware information may relate to one or more characteristics of a data storage device such as a disk drive or random access memory.

In one example, the data storage rule specifies that all data for a predetermined piece of equipment is stored in a single storage location. In other examples, the data storage rule specifies that all sensor data that is used as input by a particular analytic program is stored together. In yet other examples, the data storage rule specifies that low frequency data (i.e., data needed infrequently) is stored in a different location than high frequency data (i.e., data needed frequently). Other examples of data storage rules are possible.

In others of these embodiments, an apparatus for the dynamic optimization of stored data includes an interface and a processor. The interface has an input and an output. The processor is coupled to the interface and is configured to obtain characterization information related to time series data at the input of the interface. The processor is further configured to define a data storage rule based upon the characterization information. The rule defines at least one of a location for the storage of the time series data or a format for storage of the time series data. The processor is further configured to apply the rule to the time series data and store the time series data according to the rule via the output.

In some aspects, the data storage rule is dynamically updated and changed over time according to the characterization information. In other aspects, the characterization information may be asset model information, analytic information, or hardware information.

The asset model information relates to an operational characteristic of an asset. The asset may be an assembly line, a robotic controller, or a pumping device. Other examples of assets are possible.

The analytic information relates to an identity of one or more analytic programs. The hardware information relates to one or more characteristics of a data storage device or memory.

In one example, the rule determined by processor specifies that all data for a predetermined piece of equipment is stored in a single storage location. In another example, the rule determined by processor specifies that all sensor data that is used as input by an analytic program is stored together. In yet another example, the rule determined by processor specifies that low frequency data is stored in a different location than high frequency data.

### BRIEF DESCRIPTION OF THE DRAWINGS

For a more complete understanding of the disclosure, reference should be made to the following detailed description and accompanying drawings wherein:

FIG. 1 comprises a flowchart of one example of an embodiment for optimizing data storage according to various embodiments of the present invention;

FIG. 2 comprises a block diagram of a system for optimizing data storage according to various aspects of the present invention;

FIG. 3 comprises a block diagram of an apparatus for data storage according to various aspects of the present invention; and

FIG. 4 comprises a block diagram of a rule according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

In embodiments of the present invention described herein, data storage location decisions and/or formatting decisions are made based upon, for example, metadata and analytic requirements. In one specific example, the data contained in asset models and the information concerning the analytics workload of the system can be used to define data storage rules.

The time series data may be characterized by a variety of different factors including asset model information, analytic information, and hardware information. For example, the asset model information relates the time series data in use in the system. These models assign a structured relationship between time series values referring to a particular asset. This may include information relating to commonalities between assets and the expected frequency of generation for some time series values. To give one example, an asset model is a data structure that specifies a structured relationship between time series values referring to a particular asset.

The analytic information, in one aspect, relates to analytics routinely used in the system. This includes, but may not be limited to, information on the frequency with which analytics are run, the machines running them, the dataset requirements and the outputs generated. Other examples of analytic information is possible. Analytics may include clustering operations, rules for anomaly detection, and physics-based models to mention a few examples.

Hardware information relates to the hardware in the storage system, which will be used to determine storage and retrieval strategies based on maximizing performance. For instance, the speed or cost of the hardware may be used. Other examples of hardware information is possible.

Embodiments of the present invention described herein utilize this characterization information to characterize or define the requirements for data storage. Then, the requirements are used to form a storage plan (e.g., one or more rules). The decision as to where to locate data and which data to co-locate are made and acted upon based upon the plan or rules.

Embodiments of the present invention solve the problem of having to architect and periodically revisit the data storage layout of a system processing time series data. Rather than begin with a logical arrangement that is assumed optimal and wait for a given amount of efficiency drift before interrupting operations to adjust the arrangement, these embodiments make an active attempt to maintain optimal storage arrangement a basic function implemented in the system. In another embodiment of the present invention, long periods of analysis performed by humans to restore data storage optimality to a system as uses change are eliminated.

In still other embodiments, decreased system downtime is obtained due to having to periodically reconfigure storage decisions in the system performing analytics on the time series data. In yet another embodiment, decreased cost are obtained and these reduced costs result from less manual intervention in system maintenance and more optimal and efficient storage decisions.

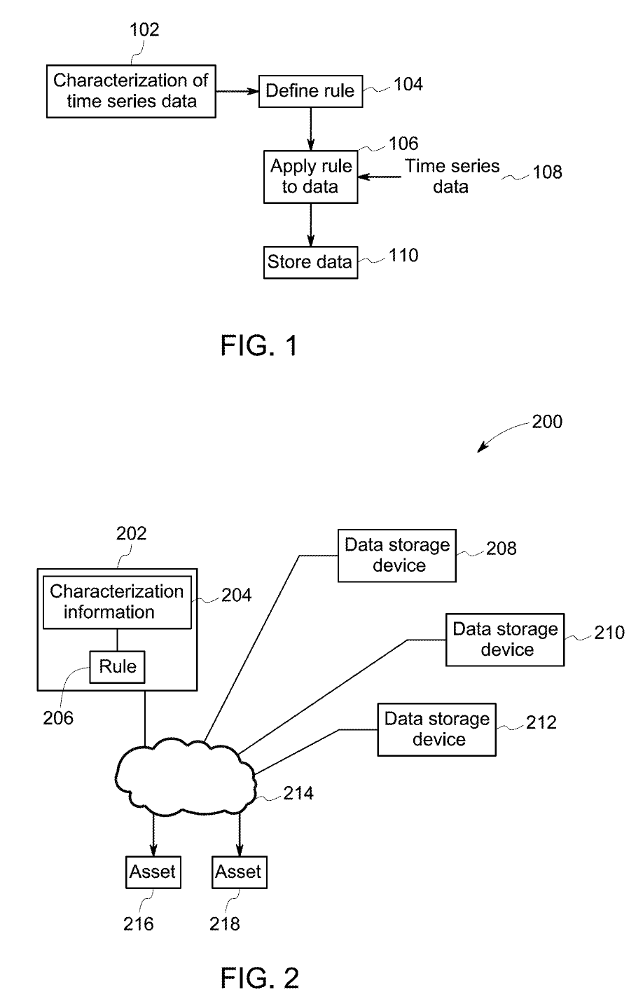

Referring now to FIG. 1, one example of an embodiment for optimizing data storage is described. At step 102, characterization of the data occurs. For example, time series data may be characterized by a variety of different factors including asset model information, analytic information, and hardware information. Asset model information relates to the time series data in use in the system. A structured relationship is assigned by these models as between time series values referring to a particular asset. This may include information relating to commonalities between assets and the expected frequency of generation for some time series values.

Analytic information relates to analytics routinely used in the system. This includes, but may not be limited to, information on the frequency with which analytics are run, the machines running them, or the dataset requirements and the outputs generated.

Hardware information relates to the hardware in the storage system, which will be used to determine storage and retrieval strategies based on maximizing performance. For instance, the speed or cost of the hardware may be used.

At step 104, a rule is defined. The rule defines how data is to be stored based upon the characterization information that has been chosen. At step 106, the rule is applied to incoming time series data 108. At step 110, the time series data 108 is stored according to the rule.

The embodiments of the present invention described in FIG. 1 can be applied continuously or periodically over time. In other words, the rules are not a static plan, but a plan that changes over time. As the characterization information changes, the rule or plan changes. Put another way, embodiments of the present invention do not form a static layout for the data of the system. Instead, changes in the system result in automatic revisions to the storage strategy.

For example, consider the example where a particular collection of time series data is co-located together and positioned on a particular set of storage nodes or devices to facilitate a particular set of analytics. If a user were to retire these analytics over a period of time, the present system responds by relaxing the constraint of storing the time series data in a manner which assists the running of those analytics. When the last analytic is retired, the system no longer stores the data in that manner unless it assists in some other use-case for the system. The reverse is true of the entry of new analytics into the system. Over time, the metadata associated with these analytics influences the storage strategy in use. By “metadata” it is meant information about the data being stored, such as where the data came from, the quality of the data, and information about any changes or modifications to the data, to name a few.

Referring now to FIG. 2, one example of a system 200 that optimizes data storage is described. The system 200 includes an optimization apparatus 202 (that includes characterization information 204 and a rule 206), a first data storage device 208, a second data storage device 210, a third data storage device 212, a network 214, a first asset 216, and a second asset 218.

The optimization apparatus 202 utilizes characterization information 204 to construct the rule 206. The rule 206 is applied against time series data. The time series data may be recently produced time series data (that originates from the first asset 216 or the second asset 218) or time series data that already is stored in the first data storage device 208, the second data storage device 210, or the third data storage device 212. The rule 206 may be applied as the new time series data as this data is received. It may also be applied periodically or continuously to the time series data that is stored in the first data storage device 208, the second data storage device 210, or the third data storage device 212. The rule 206 may also change over time as the characterization information 204 changes or as different characterization information is determined or used.

The first data storage device 208, second data storage device 210, and third data storage device 212 are any type of data storage device, permanent or temporary. For example, these devices may be long term disk, random access memories (RAMs), or another type of media. Some may be high cost/faster devices while others may be slower/low cost devices.

The network 214 is any type of network or any combination of networks such as cellular phone networks, the Internet, data networks, that allow the assets to communicate with the optimization apparatus 202 and the data storage devices 208, 210, and 212. It will be appreciated that the example of FIG. 2 is one example of an architecture of a system that implements the embodiments of the present invention described herein and that other examples are possible.

The first asset 216 and second asset 218 are any type of device that produces time series data. In one aspect, time series data is obtained by some type of sensor or measurement device that is stored as a function of time. For example, a measurement sensor may take a reading of a parameter ever so often, and each of the measurements is stored in memory. Asset model information is associated with the assets 216 and 218.

In one example of the operation of the system of FIG. 2, characterization information 204 related to time series data is obtained. A data storage rule 206 is defined based upon the characterization information 204. The rule 206 defines at least one of a location for the storage of the time series data and a format for storage of the time series data. The rule 206 is applied to the time series data and the time series data is stored according to the rule. The rule may be implemented as a data structure, programmed computer instructions running upon a processing device, hardware, or combinations of these elements.

In one aspect, the data storage rule 206 is dynamically updated and changed over time according to the characterization information. In other aspects, the characterization information 204 is asset model information, analytic information, or hardware information. Other examples are possible.

In some aspects, the asset model information relates to an operational characteristic of an asset (such as an assembly line, a robotic controller, or a pumping device). The analytic information may relate to an identity of one or more analytic programs. The hardware information may relate to one or more characteristics of a data storage device or memory. Other examples of these types of information are possible.

In one example, the data storage rule 206 specifies that all data for a predetermined piece of equipment is stored in a single storage location. In other examples, the data storage rule 206 specifies that all sensor data that is used as input by an analytic program is stored together. In yet other examples, the data storage rule 206 specifies that low frequency data is stored in a different location than high frequency data.

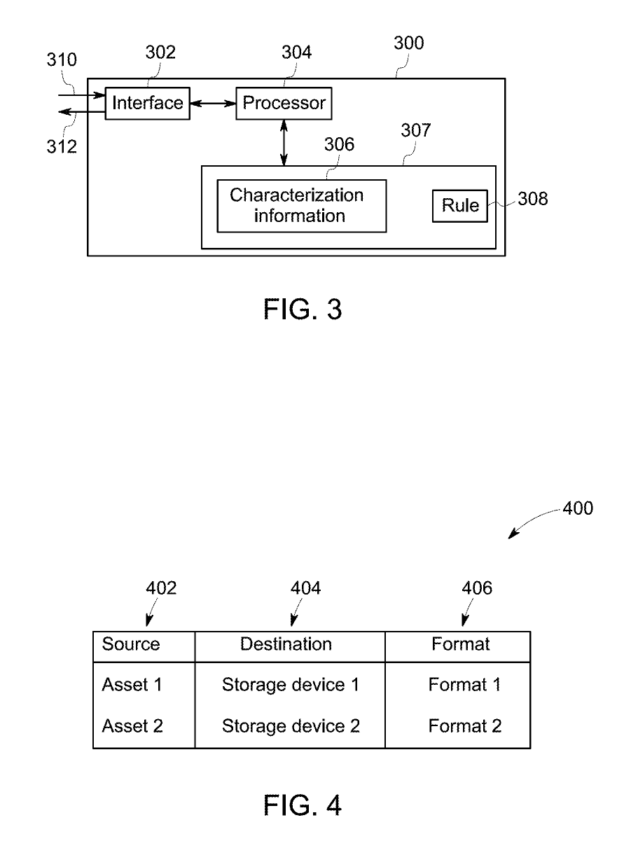

Referring now to FIG. 3, one example of an optimization apparatus 300 for optimizing data storage is described. The optimization apparatus 300 includes an interface 302 and a processor 304. The interface 302 has an input 310 and an output 312. The optimization apparatus 300 may be located on any processing device such as a server or combination of servers. The processor 304 implements programmed software instructions to implement an embodiment of the present invention described herein.

The processor 304 is coupled to the interface 302 and is configured to obtain characterization information 306 related to time series data at the input 310 contained in a memory 307. The processor 304 is further configured to define a data storage rule 308 based upon the characterization information 306. The rule 308 defines one or more of a location for the storage of the time series data or a format for storage of the time series data. The processor 304 is further configured to apply the data storage rule 308 to the time series data and store the time series data according to the rule via the output 312.

In some aspects, the data storage rule 308 is dynamically updated and changed over time according to the characterization information 306. In other aspects, the characterization information 306 may be asset model information, analytic information, or hardware information.

For example, the asset model information relates to an operational characteristic of an asset. The asset may be an assembly line, a robotic controller, or a pumping device. Other examples of assets are possible.

Additionally, the analytic information relates, in one example, to an identity of one or more analytic programs. Further, the hardware information relates to one or more characteristics of a data storage device or memory.

In one example of the operation of the apparatus of FIG. 3, the processor 304 applies the rule 308 to time series data to store all data for a predetermined piece of equipment in a single storage location. In another example, the processor 304 applies the rule 308 to time series data to store all sensor data that is used as input by an analytic program together. In yet another example, the processor 304 applies the rule 308 to time series data to store low frequency data in a different location than high frequency data.

Referring now to FIG. 4, one example of a rule 400 is described. The rule 400 uses information concerning the source 402 of time series data to specify a storage destination for the time series data. This source 402 is one of two assets (e.g., one of the two assets 216 or 218 in FIG. 2). Based upon source 402 of the assets, the rule specifies a destination 404 as a first storage device or a second data storage device. The rule 400 also specifies a format 406 as being either a first format or a second format.

It will be appreciated that the rule 400 is meant to be applied to incoming data and that other rules can be created and be applied to already stored data or to both incoming data and stored data. The rule 400 may be implemented as a data structure, programmed computer instructions running upon a processing device, hardware, or combinations of these elements.

It will be appreciated by those skilled in the art that modifications to the foregoing embodiments may be made in various aspects. Other variations clearly would also work, and are within the scope and spirit of the invention. The present invention is set forth with particularity in the appended claims. It is deemed that the spirit and scope of that invention encompasses such modifications and alterations to the embodiments herein as would be apparent to one of ordinary skill in the art and familiar with the teachings of the present application.

What is claimed is:

1. A method for the dynamic optimization of stored data, the method comprising:
obtaining characterization information related to time series data;
defining a data storage rule based upon the characterization information, the data storage rule defining at least one of a location for the storage of the time series data and a format for storage of the time series data; and
applying the rule to the time series data and storing the time series data according to the rule.

2. The method of claim 1 wherein the data storage rule is dynamically updated and changed over time according to the characterization information.

3. The method of claim 1 wherein the characterization information is a characteristic selected from the group consisting of: asset model information; analytic information; and hardware information.

4. The method of claim 3 wherein the asset model information relates to an operational characteristic of an asset, the asset selected from the group consisting of: an assembly line, a robotic controller, and a pumping device.

5. The method of claim 3 wherein the analytic information relates to an identity of one or more analytic programs.

6. The method of claim 3 wherein the hardware information relates to one or more characteristics of a data storage device or memory.

7. The method of claim 1 wherein defining the data storage rule comprises specifying that all data for a predetermined piece of equipment is stored in a single storage location.

8. The method of claim 1 wherein defining the data storage rule comprises specifying that all sensor data that is used as input by an analytic program is stored together.

9. The method of claim 1 wherein defining the data storage rule comprises specifying that low frequency data is stored in a different location than high frequency data.

10. An apparatus for the dynamic optimization of stored data, the method comprising:
an interface having an input and an output; and
a processor coupled to the interface, the processor configured to obtain characterization information related to time series data at the input, the processor further configured to define a data storage rule based upon the characterization information, the data storage rule defining at least one of a location for the storage of the time series data and a format for storage of the time series data, the processor further configured to apply the rule to the time series data and store the time series data according to the rule via the output.

11. The apparatus of claim 10 wherein the data storage rule is dynamically updated and changed over time according to the characterization information.

12. The apparatus of claim 10 wherein the characterization information is a characteristic selected from the group consisting of: asset model information; analytic information; and hardware information.

13. The apparatus of claim 12 wherein the asset model information relates to an operational characteristic of an asset, the asset selected from the group consisting of: an assembly line, a robotic controller, and a pumping device.

14. The apparatus of claim 12 wherein the analytic information relates to an identity of one or more analytic programs.

15. The apparatus of claim 12 wherein the hardware information relates to one or more characteristics of a data storage device or memory.

16. The apparatus of claim 10 wherein the processor specifies that all data for a predetermined piece of equipment is stored in a single storage location.

17. The apparatus of claim 10 wherein the processor specifies that all sensor data that is used as input by an analytic program is stored together.

18. The apparatus of claim 10 wherein the processor specifies that low frequency data is stored in a different location than high frequency data.
